(19) United States
(12) Patent Application Publication
(10) Pub. No.: US 2020/0115635 A1
(43) Pub. Date: Apr. 16, 2020

(54) Recycling and Recovering Method and System of Plastic Waste Product

(71) Applicant: Viro Group Inc., Walnut, CA (US)

(72) Inventor: Soon CHIA, Walnut, CA (US)

(21) Appl. No.: 16/709,902

(22) Filed: Dec. 10, 2019

Related U.S. Application Data
(63) Continuation-in-part of application No. 15/356,638, filed on Nov. 20, 2016, now Pat. No. 10,538,708.

(51) Int. Cl. C10B 27/06; C01B 32/05; C10J 3/84; C10G 1/10; C10B 41/00; C10B 53/07; B01D 53/14; B09B 3/00

(52) U.S. Cl. CPC C10B 27/06; C01B 32/05; C10J 3/84; C10G 1/10; C10B 41/00; C10G 2300/1003; B01D 53/1456; B09B 3/0083; C10J 2300/0946; C10J 2300/1618; C10B 53/07

(57) ABSTRACT

A recycling method for plastic waste includes the steps of: (a) placing the plastic waste into a reactor; (b) heating the plastic waste in the reactor through a pyrolysis recovery process to generate flammable gas; (c) transferring flammable gas through a condensing unit to convert the flammable gas into liquid phase products; and (d) filtering the remaining out clean gas from the flammable gas by a filtration unit. A recycling system for plastic waste includes a reactor to decompose the plastic waste to create usable fuel products; a condensing unit operatively connected with the reactor; and a filtration unit operatively connected with said condensing unit to filter the usable fuel products.

### CROSS REFERENCE OF RELATED APPLICATION

This is a Continuation-In-Part application that claims the benefit of priority under 35 U.S.C. § 120 to a non-provisional application, application Ser. No. 15/356,638, filed Nov. 20, 2016.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to all types of plastic waste in forms of an organic compound disposal method and system, and more particularly to the organic compound disposal method and system which is able to close the loop of plastic waste products (organic compound material) and its lifecycle and generate more valuable usable fuel products such as flammable hydrocarbon gas and liquid fuels.

### Description of Related Arts

Organic compounds, such as polyethylene (organic compounds) and plastic material, are widely used materials, and provide more convenient daily's life for most of people in today's world. However, the recycling and disposal treatment for the organic compounds, especially the plastic waste, always has environment issues, since the plastic waste are non-biodegradable materials. The major disposal treatment for the plastic waste is that the plastic wastes are sent and disposed in landfills where the plastic wastes cannot be decomposed for hundreds of years. In addition, the plastic waste can be buried into the oceans it is influenced by global currents that distribute it around the world. However, the above mentioned organic compound disposal treatment has the following drawback. Since the above mentioned organic compounds disposal treatments don't close the loop of the organic compounds lifecycle, the landfill capacity cannot match with the growth speed of the plastic wastes, so the other organic compound disposal treatment which is able to close the lifecycle of the plastic of the plastic wastes is highly necessary.

An improved disposal treatment for degrading the plastic wastes is provided, wherein the plastic wastes are degraded under the high temperature. In such a manner, the plastic wastes are degraded at a temperature above 400° C. under a catalyst, and the gas, oil, gum, wax, and a series of by-products are generated during the degradation. Since the by-products of the above mentioned degradation for the organic compounds waste are too complicated, the recycling treatment for the by-products is also a very important issue. In addition, the high temperature of the degradation is a high consumption reaction, so it is also not an economy organic compound disposal treatment.

### SUMMARY OF THE PRESENT INVENTION

The invention is advantageous in that it provides a recycling method and system for plastic waste which is able to not only close the loop of the plastic waste, but also can generate more valuable fuel products.

Another advantage of the invention is to provide a recycling method and system for plastic waste, wherein the recycling method and system are able to deliver plastic waste from landfill to process the pyrolysis recovery reaction, and then the usable fuel products which can be used internally or to be sold to local community.

Another advantage of the invention is to provide a recycling method and system for plastic waste, wherein the recycling method and system has one way emission control and gas treatment with energy recycle to ensure the low emission, low energy required and high process efficiency.

Another advantage of the invention is to provide a recycling method and system, wherein the plastic product is degraded through cross-alkane metathesis between the plastic waste and the alkane, so as to efficiency breakdown of PE chain into shorter chains.

Another advantage of the invention is to provide a recovering method and system, wherein the plastic product is degraded through cross-alkane metathesis between the plastic waste and the alkane, so as to efficiency breakdown of Polymers (PET, HDPE, LDPE, PP, PVC, PS, ABS, PC) and other types of plastic material chain into shorter chains.

Another advantage of the invention is to provide a recycling method and system, wherein the harmful bacteria, flies, and odor problems are efficiently eliminated in the landfill since less amount of plastic waste are deposed into the landfill, so as to prolong the lifespan of the landfill.

Additional advantages and features of the invention will become apparent from the description which follows, and may be realized by means of the instrumentalities and combinations particular point out in the appended claims.

According to the present invention, the foregoing and other objects and advantages are attained by a recycling method for plastic waste, wherein the recycling method comprises the steps of:

(a) placing the plastic waste e.g. Polymers (PET, HDPE, LDPE, PP, PVC, PS, ABS, PC) and other types of plastic material into a reactor;

(b) heating the plastic waste in the reactor through a pyrolysis recovery process to generate flammable gas;

(c) transferring flammable gas through a condensing unit to convert the flammable gas into liquid phase products; and separate non condensable gas to transfer through filtration system and; and

(d) filtering out clean gas from the remaining flammable gas by a filtration unit.

In accordance with another aspect of the invention, the present invention comprises a recycling and recovering system for plastic waste which comprises:

a reactor to decompose the plastic waste to generate usable fuel products when the plastic waste is heated in the reactor;

a condensing unit operatively connected with the reactor with unique condensing parameter setting according to the targeted input material; and

a filtration unit operatively connected with the condensing unit to separate the unwanted gas content of non condensable gas products which has just separated from the condensing unit.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a recycling method for plastic waste according to a first preferred embodiment of the present invention.

FIG. 2 is a block diagram of a recycling system for plastic waste according to a second preferred embodiment of the present invention.

FIG. 3 is a block diagram of a recycling method for plastic waste according to a third preferred embodiment of the present invention.

FIG. 4 is a block diagram of a recycling system for plastic waste according to a fourth preferred embodiment of the present invention.

FIG. 5 is a perspective view of a reactor according to the above preferred embodiments of the present invention.

### DETAILED DESCRIPTION OF THE PREFERRED EMBODIMENT

The following description is disclosed to enable any person skilled in the art to make the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

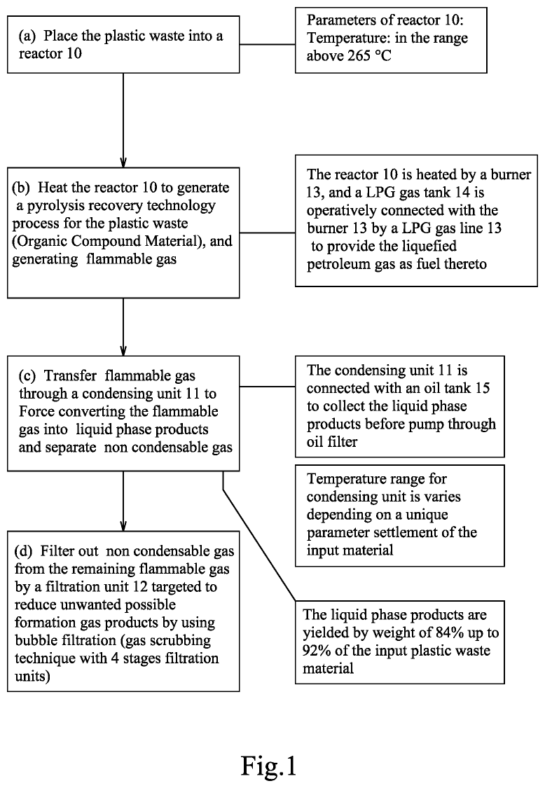

Referring to FIG. 1 of the drawings, a recycling method for all types of plastic waste according to a first preferred embodiment of the present invention, wherein the method is able to efficiently close the loop of the plastic waste lifecycle, especially for the plastic waste, and generates more valuable and environmentally sustainable usable fuel products. The method comprises the following steps.

(a) Place the plastic waste into a reactor 10.

(b) Heat the plastic waste in the reactor 10 through a pyrolysis recovery process without participation of air (Lack of mainly Oxygen and Nitrogen) to generate flammable gas.

(c) Transfer the flammable gas through a condensing unit 11 to force converting the flammable gas in gas form into liquid phase products (with a unique condensing parameter for the targeted material) and separate the non condensable gas to be transferred to filtration unit for gas cleaning process.

(d) Filter out clean gas from the remaining non condensable flammable gas by a filtration unit 12.

In the step (a), the reactor 10 is connected to a liquid spray system 101 adapted to neutralize acid gas emitted from the reaction inside the reactor 10, and the liquid spray system 101 is connected to an exhaust pipe 102, after the acid gas is neutralized through the liquid spray system 101, the neutralized acid gas can be emitted from the reactor 10 to reduce the pressure inside the reactor 10.

In the step (b), the reactor is heated by a burner 13 with operating temperature above 265° C., wherein a LPG gas tank 14 is operatively connected with the burner 13 by a LPG gas line 13 to provide the liquefied petroleum gas as fuel thereto.

In the step (c), the condensing unit 11 is connected with an oil tank 15 to collect the liquid phase products, so after the flammable gas is condensed by the condensing unit 11 to form liquid phase products and also separate the non condensable gas, the liquid phase products are collected into the oil tank 15 before pump to oil filtered. It is worth mentioning that the liquid phase products are collected from the outlet after filtered, and are prepared to the used in a machinery and engine, or applied or blended with the normal fuel, such as fuel oil, diesel, petrol and etc. to be used with petrol and diesel generator, engine or further designate system, such as gas or jet turbines.

In the step (c), the liquid phase products are by weight of 84% to 92% of the plastic waste.

In the step (d), the filtration system 12 is connected with the condensing unit 11 and the burner 13, wherein the filtration system 12 is connected with the burner 13 by a return flammable gas line 121, so while the remaining non condensable flammable gas is delivered to and filtered into the filtration system 12, the clean gas is delivered back to the burner 13 by the return flammable gas line 121 to be used to generate heat energy to the reactor 10 and then emit to the outside of the system with lower emission due to clean gas combustion with High temperature. It is worth mentioning that the clean gas is non-toxic gas acceptable to be released to the environment.

Accordingly, there are four usable fuel products generated from the method: fuel oil, carbon char, flammable gases, and electricity power, wherein the carbon char is qualitied as activated carbon which is a final stage solid recourse in the reactor 10.

Accordingly, in the step (b), the plastic waste is heated into the reactor through a pyrolysis recovery technology. In the reactor, the plastic waste is degraded based on a tandem catalytic cross alkane metathesis (CAM) process. For example, the plastic product is polyethylene (PE) polymer. The PE degradation involves one catalyst for alkane hydrogenation and another catalyst for olefin metathesis, wherein the PE degradation comprises the following steps:

(1) adding dehydrogenation catalyst to remove hydrogen from both PE and a light alkane to create unsaturated olefins; and

(2) adding olefin metathesis catalyst to scramble the unsaturated olefins, and the following by hydrogenation to breakdown PE chains.

In the step (1), the dehydrogenation catalyst can be a supported “princer”-ligated iridium complex, such as (^{t-Bu}PCP)IrH₂ and Brookhart's bis(phosphinite)-ligated (^{t-Bu}POCOP)Ir complex, such as (t-Bu₂PO-^{t-bu}POCOP)Ir(C₂H₄) or (MeO-^{i-Pr}POCOP)Ir(C₂H₄) and the dehydrogenation catalyst is adapted to remove hydrogen from both the PE and the light alkane in a sealed system.

In step (1), the light alkane can be n-hexane.

In step (2), the olefin metathesis catalyst can be Re₂O₇/γ-Al₂O₃.

In the step (2), the PE is degraded into liquid fuels and waxes, and the excess light alkanes is repetitively processed CAM results in degradation of PE into short alkane appropriate for us as transportation oil.

In the step (c), the reactor 10 is further connected to a control unit 18 to adjust parameter inside the reactor 10, wherein the control unit 18 comprises a digital control module 181, a monitoring module 182, and a multi data logger 183, wherein the digital control module 181 is adapted to adjust temperature, pressure, and reaction time of the reactor 10, and the amount of catalytic converting into the reactor 10, wherein the monitoring module 182 is a screen to display the parameters for the pyrolysis recovery reaction, wherein the multi data logger 183 is adapted to save results of the pyrolysis recovery reaction.

It is worth mentioning that the reactor 10 is further connected to a heat exchanger 16 to recycle the thermal usage from the reactor 10 and a water tank 17 to provide cool water to the reactor 10, and the water tank 17 comprises a water pump 171 to control the amount of water delivered into the reactor 10. Accordingly, the reaction inside the reactor 10 can generate certain amount of heat energy, and the heat energy can be recycled for other purpose's use through the heat exchanger 16. For example, the heat energy can be transferred into electric energy to provide electric power to our daily life.

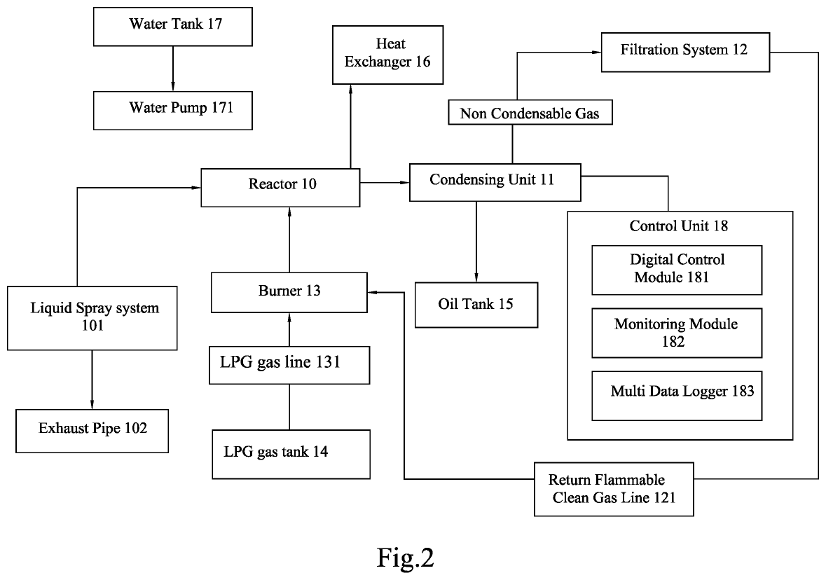

Referring to FIG. 2 of the drawings, a recycling system for plastic waste according to a second preferred embodiment of the present invention is illustrated, wherein the recycling system comprises a reactor 10 adapted to decompose the plastic waste, a condensing unit 11 operatively connected with the reactor 10, a filtration system 12 operatively connect with the condensing unit 11.

The plastic wastes are disposed in the reactor to process the pyrolysis recovery reaction. After the plastic waste are processed by the pyrolysis recovery reaction, the pyro gas is generated and transferred to the condensing unit 11, and is condensed by the condensing unit 11 to form energy liquid (liquid phase product). And, the system further comprises an oil tank 15 connected to condensing unit 11 to collect the liquid phase products, so after the flammable gas is condensed by the condensing unit 11 to form liquid phase products, the liquid phase products are collected into the oil tank 15. It is worth mentioning that the liquid phase products are collected from the outlet, and are prepared to be used in a machinery and engine, or applied or blended with the normal fuel, such as fuel oil, diesel, petrol and etc. to be used with petrol and diesel generator, engine or further designate system, such as gas or jet turbines.

It is worth mentioning that the system further comprises a burner 13, a LPG gas tank 14, and a LPG gas line 13 connected between the burner 13 and the LPG gas tank 14 to provide the liquefied petroleum gas as fuel from the LPG gas tank 14 to the burner 13. And, the system further comprises a control unit 18 operatively connected with the reactor 10, wherein the control unit 18 comprises a digital control module 181, a monitoring module 182, and a multi data logger 183, wherein the digital control module 181 is adapted to a adjust temperature, pressure, and reaction time of the reactor 10, and the amount of catalytic converting into the reactor 10, wherein the monitoring module 182 is a screen to display the parameters for the pyrolysis recovery reaction, wherein the multi data logger 183 is adapted to save results of the pyrolysis recovery reaction.

Accordingly, the system further comprises a liquid spray system 101 connected to the reactor 10 adapted to neutralize acid gas emitted from the reaction inside the reactor 10, and the liquid spray system 101 connected to an exhaust pipe 102, so after the acid gas is neutralized through the liquid spray system 101, the neutralized acid gas can be emitted from the reactor 10 to reduce the pressure inside the reactor 10.

Accordingly, the filtration system 12 is operatively connected to the condensing unit 11 and the burner 13, wherein the filtration system 12 is adapted to filter the remaining flammable gas to form clean gas, so after the remaining flammable gas generated from the reaction inside the reactor is filtered inside the filtration system 12, the clean gas can be emitted to outside, and the remaining flammable gas is delivered back to the burner 13 through the return flammable gas line 121.

It is worth mentioning that the reaction inside the reactor 10 is the same as mentioned in the first preferred embodiment of the present invention, which is that the plastic waste is heated into the reactor through a pyrolysis recovery technology. In the reactor, the plastic waste is degraded based on a tandem catalytic cross alkane metathesis (CAM) process.

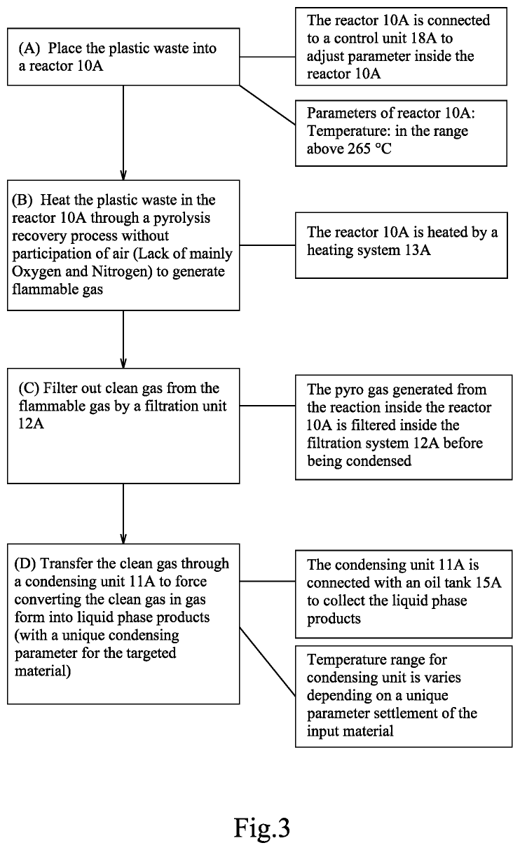

Referring to FIG. 3 of the drawings, a recycling method for plastic waste according to a third preferred embodiment of the present invention is illustrated, wherein the method is able to efficiently close the loop of the plastic waste lifecycle, especially for the plastic waste, and generates more valuable and environmentally sustainable usable fuel products.

The method comprises the following steps.

(A) Place the plastic waste into a reactor 10A.

(B) Heat the plastic waste in the reactor 10A through a pyrolysis recovery process without participation of air (Lack of mainly Oxygen and Nitrogen) to generate flammable gas.

(C) Filter out clean gas from the flammable gas by a filtration unit 12A.

(D) Transfer the clean gas through a condensing unit 11A to force converting the clean gas in gas form into liquid phase products (with a unique condensing parameter for the targeted material).

In the step (A), the reactor 10A is connected to a liquid spray system 101 adapted to neutralize acid gas emitted from the reaction inside the reactor 10A, and the liquid spray system 101A is connected to an exhaust pipe 102A, after the acid gas is neutralized through the liquid spray system 101A, the neutralized acid gas can be emitted from the reactor 10A to reduce the pressure inside the reactor 10A.

In the step (B), the reactor is heated by a heating system 13A with operating temperature above 265° C. Preferably, the reactor is heated by the heating system 13A with operating temperature above 400° C.

In the step (C), the filtration system 12A is connected with the reactor 10A and the condensing unit 11A, wherein the flammable gas generated in the reactor 10A is filtrated by the filtration unit 12A before reach to the condensing unit 11A, wherein the clean gas filtered out by the filtration unit 12A is condensed to be clean liquid phase products by the condensing unit 11A.

In the step (D), the condensing unit 11A is connected with an oil tank 15A to collect the liquid phase products, so after the clean gas is condensed by the condensing unit 11A to form liquid phase products and also separate the non condensable gas, the liquid phase products are collected into the oil tank 15A. It is worth mentioning that the liquid phase products are collected from the outlet after condensed, and are prepared to the used in a machinery and engine, or applied or blended with the normal fuel, such as fuel oil, diesel, petrol and etc. to be used with petrol and diesel generator, engine or further designate system, such as gas or jet turbines.

In the step (D), the weight of the condensed liquid phase products are 84% to 92% of the weight of the plastic waste placed into the reactor 10A in step (A).

According to the third preferred embodiment of the present invention, the condensing unit 11A is connected with the filtration unit 12A and the heating system 13A, wherein the condensing unit 11A is connected with the heating system 13A by a return flammable gas line 121A, so that the non-condensed clean gas is delivered back to generate energy to the reaction in the reactor 10A.

Accordingly, there are four usable fuel products generated from the method: fuel oil, carbon char, flammable gases, and electricity power, wherein the carbon char is qualified as activated carbon which is used to provide energy to the reaction in the reactor 10A.

Accordingly, in the step (B), the plastic waste is heated in the reactor 10A through a pyrolysis recovery technology. In the reactor, the plastic waste is degraded based on a tandem catalytic cross alkane metathesis (CAM) process. For example, the plastic product is polyethylene (PE) polymer. The PE degradation involves one catalyst for alkane hydrogenation and another catalyst for olefin metathesis, wherein the PE degradation comprises the following steps:

(i) adding dehydrogenation catalyst to remove hydrogen from both PE and a light alkane to create unsaturated olefins; and

(ii) adding olefin metathesis catalyst to scramble the unsaturated olefins, and the following by hydrogenation to breakdown PE chains.

In the step (i), the dehydrogenation catalyst can be a supported “princer”-ligated iridium complex, such as (^{t-Bu}PCP)IrH₂ and Brookhart's bis(phosphinite)-ligated (^{t-Bu}POCOP)Ir complex, such as (t-Bu₂PO-^{t-bu}POCOP)Ir(C₂H₄) or (MeO-^{i-Pr}POCOP)Ir(C₂H₄) and the dehydrogenation catalyst is adapted to remove hydrogen from both the PE and the light alkane in a sealed system.

In step (i), the light alkane can be n-hexane.

In step (ii), the olefin metathesis catalyst can be Re₂O₇/γ-Al₂O₃.

In the step (ii), the PE is degraded into liquid fuels and waxes, and the excess light alkanes is repetitively processed CAM results in degradation of PE into short alkane appropriate for us as transportation oil.

According to the third preferred embodiment of the present invention, the reactor 10A is further connected to a control unit 18A to adjust parameter inside the reactor 10A, wherein the control unit 18A comprises a digital control module 181A, a monitoring module 182A, and a multi data logger 183A, wherein the digital control module 181A is adapted to adjust temperature, pressure, and reaction time in the reactor 10A, and the amount of catalytic converting into the reactor 10A, wherein the monitoring module 182A is a screen to display the parameters for the pyrolysis recovery reaction, wherein the multi data logger 183A is adapted to save results of the pyrolysis recovery reaction.

It is worth mentioning that the reactor 10A is further connected to a heat exchanger 16A to recycle the thermal usage from the reactor 10A and a water tank 17A to provide cool water to the reactor 10A. In detail, the water tank 17A is connected with a water pump 171A which is connected to the reactor 10A to control the amount of water delivered into the reactor 10A. Accordingly, the reaction inside the reactor 10A can generate certain amount of heat energy, and the heat energy can be recycled for other purpose's use through the heat exchanger 16A. For example, the heat energy can be transferred into electric energy to provide electric power.

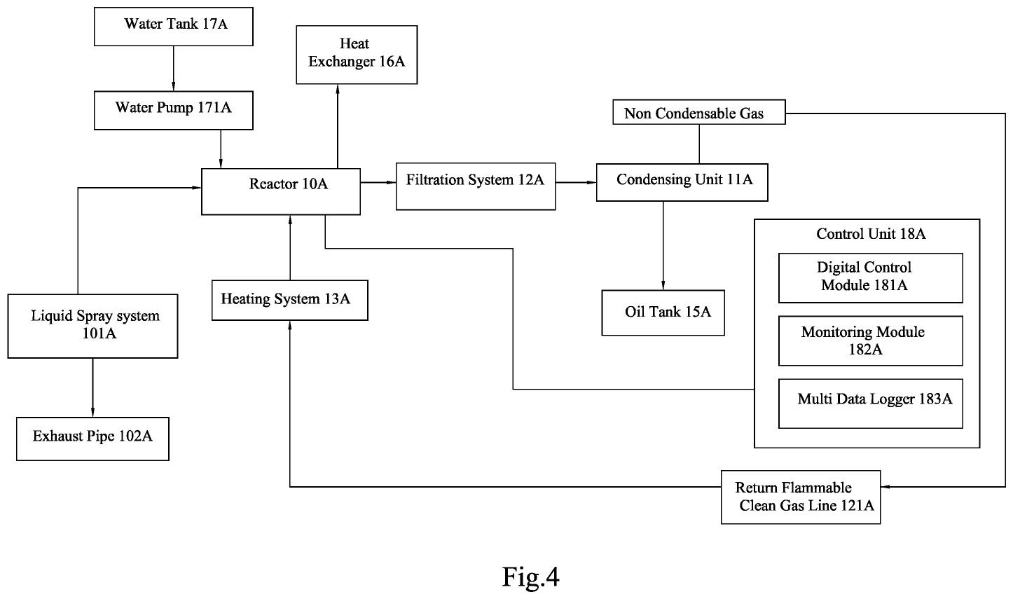

Referring to FIG. 4 of the drawings, a recycling system for plastic waste according to a fourth preferred embodiment of the present invention is illustrated, wherein the recycling system comprises a reactor 10A adapted to decompose the plastic waste, a filtration system 12A operatively connect with the reactor 10A, a condensing unit 11A operatively connected with the filtration system 12A.

The plastic wastes are disposed in the reactor 10A to process the pyrolysis recovery reaction. After the plastic waste are processed by the pyrolysis recovery reaction, the pyro gas is generated and transferred to the filtration system 12A to filter out the clean gas, the clean gas is transferred to the condensing unit 11A, and is condensed by the condensing unit 11A to form energy liquid (liquid phase product). And, the system further comprises an oil tank 15A connected to condensing unit 11A to collect the liquid phase products, so after the clean gas is condensed by the condensing unit 11A to form liquid phase products, the liquid phase products are collected into the oil tank 15A. It is worth mentioning that the liquid phase products are collected from the outlet, and are prepared to be used in a machinery and engine, or applied or blended with the normal fuel, such as fuel oil, diesel, petrol and etc. to be used with petrol and diesel generator, engine or further designate system, such as gas or jet turbines.

It is worth mentioning that the system further comprises a heating system 13A to provide thermal energy to the reaction in the reactor 10A. And, the system further comprises a control unit 18A operatively connected with the reactor 10A, wherein the control unit 18A comprises a digital control module 181A, a monitoring module 182A, and a multi data logger 183A, wherein the digital control module 181A is adapted to adjust temperature, pressure, and reaction time in the reactor 10A, and the amount of catalytic converting into the reactor 10A, wherein the monitoring module 182A is a screen to display the parameters for the pyrolysis recovery reaction, wherein the multi data logger 183A is adapted to save results of the pyrolysis recovery reaction.

According to the third preferred embodiment of the present invention, the control unit 18A s also operatively connected with the condensing unit 11A, so as to control parameter of said condensing unit 11A.

Accordingly, the system further comprises a liquid spray system 101A connected to the reactor 10A adapted to neutralize acid gas emitted from the reaction inside the reactor 10A, and the liquid spray system 101A connected to an exhaust pipe 102A, so after the acid gas is neutralized through the liquid spray system 101A, the neutralized acid gas can be emitted from the reactor 10A to reduce the pressure inside the reactor 10A.

Accordingly, the filtration system 12A is operatively connected to the reactor 10A and the condensing unit 11A, wherein the filtration system 12A is adapted to filter the pyro gas generated in the reactor 10A to form clean gas. The condensing unit 11A is operatively connected to the filtration system 12A and the heating system 13A, so after the pyro gas generated from the reaction inside the reactor 10A is filtered inside the filtration system 12A, the clean gas is condensed to be liquid phase product, and the remaining flammable gas which is not condensed in the condensing unit 11A is delivered back to the heating system 13A through the return flammable gas line 121A to provide energy to the heating system 13A, and further provide energy to the reaction in the reactor 10A.

It is worth mentioning that the reaction inside the reactor 10A is the same as mentioned in the third preferred embodiment of the present invention, which is that the plastic waste is heated into the reactor 10A through a pyrolysis recovery technology. In the reactor 10A, the plastic waste is degraded based on a tandem catalytic cross alkane metathesis (CAM) process.

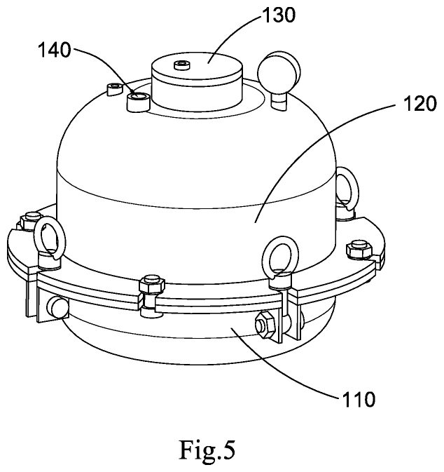

FIG. 5 illustrates a reactor 10B of the pyrolysis recovery reaction of the plastic waste according to the preferred embodiments of the present invention. The reactor 10B comprises a first reactor body 110B and a second reactor body 120B tight coupled with the first reactor body 110B in a detachable connection manner. The first reactor body 110B is a lower bowl shaped body and the second reactor body 120B is an upper body having a height longer than the height of the first reactor body 110B which is configured to collect the residual matter such as carbon char product after the pyrolysis recovery reaction while the upper second reactor body 120B is large enough for receiving gas product and processing pyrolysis reaction. Accordingly, after the pyrolysis recovery reaction, the carbon char product which is a final stage solid recourse in the reactor 10B is remained in the first reactor body 110B. Since the first reactor body 110B is at the lower position and has a shorter height so that, after the second reactor body 120B is detached from the first reactor body 110B, the user may simply replace another clean first reactor body 110B to fasten with the second reactor body 120B to facilitate the continuous of the pyrolysis reaction and the user may easily remove the carbon char product from the first reactor body 110 conveniently.

The reactor 10B further comprises a cover 130B tight coupled with the second reactor body 120B in a detachable connection manner, so that the plastic waste can be put into the reactor 10B easily.

The second reactor body 120B has an opening 140B, so that the flammable gas in the reactor can be transferred out of the reactor 10B.

It is worth mentioning that both the reactor 10 according to the first preferred embodiment and the second preferred embodiment and the reactor 10A according to the third preferred embodiment and the fourth preferred embodiment can be embodied as the reactor 10B according to the fifth preferred embodiment.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for recycling plastic waste, comprising the steps of:
(A) placing the plastic waste into a reactor;
(B) heating said plastic waste in said reactor through a pyrolysis recovery process to generate flammable gas;
(C) filtering out clean gas from the flammable gas by a filtration unit; and
(D) transferring the clean gas through a condensing unit to convert the clean gas in gas form into liquid phase products.

2. The method as recited in claim 1, wherein in said step (B), said plastic waste is heated in said reactor by a heating system with an operating temperature above 265° C.

3. The method as recited in claim 1, wherein in said step (C), a heating system is operatively connected to said reactor, wherein said heating system is operated for heating said plastic waste in said reactor.

4. The method as recited in claim 1, wherein said plastic waste are recycled and transformed to four usable fuel products of fuel oil, carbon char, flammable gases, and electricity power.

5. The method as recited in claim 1, wherein in step (A), said reactor is connected to a liquid spray system to neutralize acid gas emitted from a reaction inside the reactor, and said liquid spray system is connected to an exhaust pipe to reduce the pressure inside said reactor.

6. The method as recited in claim 1, wherein in step (D), said condensing unit is connected with an oil tank to collect said liquid phase products.

7. The method as recited in claim 1, further comprising a step of recycling a thermal usage from said reactor via a heat exchanger connected to said reactor by delivering cool water from a water tank to said reactor.

8. A recycling and recovering system for plastic waste, comprising:
a reactor for placing the plastic waste thereinto to decompose the plastic waste to generate usable fuel products when the plastic waste is heated in said reactor;
a filtration unit operatively connected with said reactor to filter usable fuel products to obtain clean gas products; and
a condensing unit operatively connected with said filtration unit, wherein said condensing unit converts said clean gas products into liquid phase products.

9. The recycling and recovering system as recited in claim 8, wherein the plastic waste are disposed in said reactor to process a pyrolysis recovery reaction, wherein said reactor comprises a first reactor body and a second reactor body tightly coupled with said first reactor body in a detachable connection manner, wherein said first reactor body is a lower bowl shaped body and said second reactor body is an upper body having a height longer than a height of said first reactor body.

10. The recycling and recovering system as recited in claim 9, wherein said reactor further comprises a cover tightly coupled with said second reactor body in a detachable connection manner, so that the plastic waste can be put into said reactor easily, wherein said second reactor body has an opening, so that the flammable gas in the reactor can be transferred out of said reactor.

11. The recycling and recovering system as recited in claim 9, wherein the plastic waste is heated inside said reactor by a heating system with an operating temperature above 400° C.

12. The recycling and recovering system as recited in claim 9, further comprising a liquid spray system connected to said reactor to neutralize acid gas emitted from the reaction inside said reactor and an exhaust pipe connected to said liquid spray system to reduce pressure inside side reactor, and an oil tank connected with said condensing unit to collect the liquid phase products.

13. The recycling and recovering system as recited in claim 11, wherein said condensing unit is connected with said heating system by a return flammable gas line, so the non-condensed clean gas can be delivered by to said heating system by said return flammable gas line.

14. The recycling and recovery system as recited in claim 9, further comprising a control unit operatively connected with said reactor to control parameters of said reactor.

15. The recycling and recovery system as recited in claim 14, wherein said control unit comprises a digital control module to adjust parameters of said reactor, a monitoring module to display the parameters for the pyrolysis recovery reaction, and a multi data logger to save results for the pyrolysis recovery reaction.

16. The recycling and recovery system as recited in claim 14, wherein said control unit is operatively connected with said condensing unit to control parameter of said condensing unit.

17. The recycling and recovery system as recited in claim 9, further comprising a heat exchanger connected to said reactor to recycle a thermal usage from said reactor and a water tank connected to said the rector to provide cool water thereto.

18. The recycling and recovery system as recited in claim 17, further comprising a water pump connected with said water tank to control the amount of water delivered into said reactor.

19. A recycling and recovering system for plastic waste, comprising:
a heating system;
a reactor, wherein the plastic waste is heated in said reactor by said heating system to generate usable fuel products in gas form;
a filtration system operatively connected with said reactor to filtrate said usable fuel products, so as to obtain clean gas;
a condensing unit operatively connected with said reactor, wherein said condensing unit converts said clean gas into liquid phase products;
a liquid spray system connected to said reactor to neutralize acid gas emitted from a reaction inside said reactor; and
an exhaust pipe connected to said liquid spray system for discharging the neutralize acid gas from said reactor to reduce pressure inside said reactor after the acid gas is neutralized.

20. The recycling and recovery system as recited in claim 19, further comprising a return flammable gas line, wherein said filtration system is connected with said heating system by said return flammable gas line, so after the clean gas passed through the condensing unit, the remaining non-condensed gas is delivered back to said heating system by said return flammable gas line.

21. The recycling and recovery system as recited in claim 19, wherein the plastic waste are disposed in said reactor to process a pyrolysis recovery reaction, wherein said reactor comprises a first reactor body and a second reactor body tightly coupled with said first reactor body in a detachable connection manner, wherein said first reactor body is a lower bowl shaped body and said second reactor body is an upper body having a height longer than a height of said first reactor body.

22. The recycling and recovering system as recited in claim 21, wherein said reactor further comprises a cover tightly coupled with said second reactor body in a detachable connection manner, so that the plastic waste can be put into said reactor easily, wherein said second reactor body has an opening, so that the flammable gas in the reactor can be transferred out of said reactor.

23. The recycling and recovery system as recited in claim 21, wherein the plastic waste is heated in said reactor by side heating system with an operating temperature above 400° C., wherein a plastic degrading catalyst is added into said reactor for degrading the plastic waste.

24. The recycling and recovery system as recited in claim 21, further comprising an oil tank connected with said condensing unit to collect the liquid phase products and a control unit operatively connected with said reactor to control parameters of said reactor and to control parameter of said condensing unit.

25. The recycling and recovery system as recited in claim 24, wherein said control unit comprises a digital control module to adjust parameters of said reactor, a monitoring module to display the parameters for the pyrolysis recovery reaction, and a multi data logger to save results for the pyrolysis recovery reaction.

26. The recycling and recovery system as recited in claim 21, further comprising a heat exchanger connected to said reactor to recycle a thermal usage from said reactor and a water tank connected to said the rector to provide cool water thereto.

27. The recycling and recovery system as recited in claim 26, further comprising a water pump connected with said water tank to control the amount of water delivered into said reactor.
